(19) United States
(12) Patent Application Publication
(10) Pub. No.: US 2005/0196259 A1
(43) Pub. Date: Sep. 8, 2005

(54) Method and apparatus for loading and/or unloading objects from and/or retaining objects in a transportation or storage container

(76) Inventor: Gregory G. Gilson, Bloomfield Hills, MI (US)

Correspondence Address: The Weintraub Group, P.L.C., Suite 240, 32000 Northwestern Highway, Farmington Hills, MI, 48334, US

(21) Appl. No.: 11/063,320

(22) Filed: Feb. 22, 2005

Related U.S. Application Data
(60) Provisional application No. 60/545,891, filed on Feb. 19, 2004.

(51) Int. Cl. B60P 1/00

(52) U.S. Cl. 414/527

(57) ABSTRACT

A method and apparatus for unloading and/or retaining objects in and/or from a stationary or mobile storage container, such as a pick-up truck. An unloader/retainer bar, specially configured cleats, and elongated pulling material, such as a rope, are associated to enable a user at a loading/unloading end of a cargo storage area, such a truck bed, to remove and/or unload objects from the storage area from the loading end of the truck, store and retain objects at a remote interior location in the storage area, such as adjacent to the passenger cab of the truck, and retain, position, or otherwise inhibit objects from falling out of the loading end of the truck, such as in conjunction with the tail gate of the truck at the loading/unloading end of the truck.

### CROSS-REFERENCE TO RELATED APPLICATIONS

This application is a completion application of co-pending U.S. Provisional Patent Application Ser. No. 60/545,891, filed Feb. 19, 2004, the entire disclosure of which is hereby incorporated by reference.

### BACKGROUND OF THE INVENTION

1. Field of the Invention

This invention relates to a method and an apparatus for unloading objects from, or retaining objects in, a stationary or mobile storage container, such as a pickup truck. More particularly, this invention pertains to a retaining arrangement and the use of an unloader/retainer bar, a pair of cleats, and elongated pulling material, such as a rope, which are associated to enable unloading of objects stored at a remote interior end of the storage container by a user at the loading end or, to secure objects while in transit, and inhibit objects from falling out of the loading end of a pickup truck.

2. Description of Related Art

Pickup trucks have a cargo bed with a rear tail gate that tilts downward to permit loads to be placed onto the cargo bed for transport. Vans have rear doors which open to provide access to the cargo area so that objects can be placed into and removed from the van. Typically, one or more persons carry a load to and from the pickup truck or van. After the object is emplaced on the cargo bed, the object is put into place in a final desired position, such as by being pushed to the back interior end of the truck bed. If the load slides to the front of the bed, i.e. toward the passenger cab, or is made up of many of articles, it becomes cumbersome for an individual to remove the articles while standing at the tailgate. If the load is relatively heavy or cumbersome for people to carry and handle, removal of the object from the truck is very difficult and some type of industrial apparatus is used to assist the worker in removing the load from the bed.

Arrangements for retaining and unloading objects from a transportation or storage container, such as a truck, are known. Illustrative are the arrangements disclosed in U.S. Pat. No. 939,758 to Tillery; U.S. Pat. No. 3,074,571 to Dean; U.S. Pat. No. 3,324,595 to Loomis; U.S. Pat. No. 4,099,636 to Frenette; U.S. Pat. No. 4,277,220 to Wiley; U.S. Pat. No. 4,842.471 to Hodgetts; U.S. Pat. No. 5,538,302 to Travis; U.S. Pat. NO. 5,395,204 to Balik; U.S. Pat. No. 5,862,650 to Adams et al; U.S. Pat. No. 6,086,313 to Plaehn; and U.S. Pat. No. 6,635,335 to Benson et al.

Such arrangements are believed to have been suitable for the specific purposes desired. However, some of the above-noted arrangements are complex, specific to a particular application, or lack versatility.

There is an ongoing need for improvements in unloading and retention arrangements. For example, a small business entrepreneur may lack personnel and equipment needed to load and load inventory, not only in the storage area of a stationary warehouse but also on a delivery truck and the like. In a time strapped day, the entrepreneur needs time and energy saving tools, such as in loading and unloading inventory of the business. The entrepreneur oftentimes needs flexibility and solutions in unloading as well as in retention, such as when differently configured items are to be transported on a pickup truck.

Therefore, it is desirable to provide apparatus which is attached to a vehicle to enhance the unloading of objects from the interior end of a cargo bed (or storage container), which is remote to the exterior loading area thereof, and also may retain (or otherwise inhibit or prevent) objects from sliding outwardly or inwardly from the loading end of the cargo bed, once emplaced thereon. Because such apparatus is disposed in cargo bed of the vehicle, the apparatus may in some applications interfere with the ability to carry certain types of loads for which the apparatus is not required. As such, it is desirable that the unloading and retention apparatus be easily removable from the vehicle by the user.

An object of this invention is the provision of apparatus useful in unloading objects from a storage container, stationary or mobile, and in retaining objects on the cargo bed of a mobile transporter, that overcomes the disadvantages of the prior art.

Another object of this invention is the provision of simple mechanical apparatus, which enables the easy unloading of stored objects from the back of a pickup truck or like mobile transporter.

Yet another object of this invention is the provision of mechanical apparatus, which is low in cost, versatile, and easily installed and/or removed without complex tools in a variety of mobile transport vehicles, such as a pickup truck, van, boat storage bay or the like wherein to provide enable unloading and retention of objects on the cargo bed or bay.

Yet another object of this invention is the provision of mechanical apparatus that can be hand operated by individuals in the field, which apparatus requires little or no technical expertise.

Yet another object of this invention is the provision of a dual pull apparatus, utilizing a manually pulled article holder, such as a pull bar, elongated tube, or flexible holder such as a tube or strap; a pair of rope securement cleats; and a pull member, such as a cable, strap, chain, or rope, that can be custom fit to meet a variety of specific applications.

A yet further object of this invention is the provision of a method of loading and unloading objects from a storage container, whether mobile or stationary, and retaining or otherwise inhibiting objects from sliding outwardly, or inwardly, from the loading end of the mobile transporter, depending on the need and application.

A yet further object of this invention is the provision of an object holding and retention arrangement, such as in combination with the tail gate of a pick up truck, wherein objects are positioned by a holder on or against the tail gate, such as when the gate is down and in a truck open for loading position and/or when the gate is up and in closing relation with the loading end of the truck.

Further and according to an important aspect of this invention an object is the provision of new and improved pull rope retaining apparatus, such as wire or rope or the like retaining cleats, and object holders used in combination with truck structure.

### SUMMARY OF THE INVENTION

The present invention is directed to a dual pull unloader mechanism for placement and, preferably, for use with a pickup truck or truck trailer, or other cargo bay having a flat bed portion, a front wall, and a back end portion formed in part by a pair of opposed vertical sidewalls, comprising:
an unloader bar having opposite ends, including a left end and a right end, the unloader bar being adapted to be engaged by and engage objects loaded on the bed portion and be moved across the bed portion, between the sidewalls, and in directions away from and towards said open back end portion;
at least one pull line, having a length greater than the distance between the front wall and the back end portion of the bed portion, a portion of said pull line being associated with said unloader bar; and
a left and a right cleat, each said cleat being mounted to a respective side wall or bed portion proximate to the back end portion of the bay and adapted to secure the free ends of the pull line wrapped therearound,
wherein for loading the unloader bar is positioned toward the front wall of the bay, such as by objects being loaded being pushed from the back end portion of the bay towards the front wall, and the free end portion of the pull line being wrappingly secured about a respective cleat, and for unloading, the pull line is unsecured and used to apply substantially an even pull force to the unloader bar and progressively pull the bar against the objects and the objects towards the open back end portion of the truck.

According to this invention, a cleat member comprises: a first portion and a second portion disposed generally symmetrically about a medial line, each portion including a forward and a rearward end and a pair of opposed sidewalls, each pair of sidewalls forming a lateral open throat sized to receive and removably retain a length of pull line inserted therewithin and said throats opening and facing in opposite directions, the sidewalls of each said throats including a plurality of upstanding ribs for gripping an axial portion of a pull line forced between the sidewalls and towards the medial line, the ribs in said and throats being at like acute angles to the medial line and in a direction towards the forward end of each said portion, wherein to grip and inhibit axial withdrawal forces operating to pull the pull line from the throat.

According to preferred aspects of this invention, the cleats are capable of being removably mounted to a respective sidewall or flatbed of a pickup truck, such as by a mounting bracket with suitable fasteners, and each cleat may be formed as a one-piece unit or assembled from two or more portions.

In one preferred aspect, the cleat includes a mounting plate for mounting the cleat to an interior portion of the flat bed proximate the tailgate of a pickup truck. The medial line is generally parallel to the cargo bed of the pickup truck, and the ribs on the left cleat and the right cleat each angle in a direction from the open end towards the front of the pickup truck.

According to a preferred aspect, the lateral and lower portions of the cleats are separate, and include a central base. The central bases are fastened to one another and the assembly fastened to the mounting plate.

According to another preferred aspect, the upper and the lower portions of the cleat member are unitary.

Whether formed as one-piece, or assembled, the cleat member is preferably comprised of a substantially firm material, such as an elastomer or a polymer. The portions defining the cleat have, in plan, an exterior shape that is generally oblate (i.e., like a flattened sphere), having a narrower rearward end, that is proximate to the open end, and expanding towards a larger central area, then tapering or narrowing toward the forward end, facing the front wall.

Preferably, each respective pair of sidewalls form a lateral or upwardly open, generally V-shaped throat, wherein opposed interior faces of the throat are at an acute angle to the plane of the medial line, the ribs are upstanding from the opposed interior faces, and the respective ribs are generally V-shaped in cross-section.

According to this invention, the interior faces that form the V-shaped throat define a double included angle of about 18°-25°, and have a lateral separation that is, at least in part, less than the outer diameter of a pull line that is to be inserted into the throat. The ribs are at an angle of about 30°-45° to the medial line.

This invention provides as an unloader that helps reduce the work necessary to unload objects from pick-up trucks and like storage containers. In an important aspect, the unloader described hereinabove also functions as a retention system.

According to this aspect, the objects are loaded onto the bed portion, the unloader bar is placed at the open back end of the truck, wherein to inhibit objects from sliding out of the truck bed, and the two pull lines at the opposite ends of the unloader bar are secured to the respective left and right cleats.

Further and according to this invention, there is provided a method for unloading objects from and retaining objects in a cargo bay and, preferably, in a pickup truck or truck trailer, including a bed portion, a loading end, a front wall, an open back end portion and a left and a right sidewall extending between the front wall and the open back end, the steps of the method comprising:
providing apparatus for unloading and retaining, said apparatus comprising a left and a right cleat for receiving a pull line wrapped thereabout, the cleats respectively mounted to either a left or right sidewall, or left or right side of the bed, each cleat having two lateral throats facing in opposite directions, an elongated unloader bar having opposite ends, at least one pull line of a length greater than the distance between said front wall and the open back end, at least one pull line having opposite free ends and a medial portion connected the unloader bar and having the free ends adapted to be received in and wrapped about the opposed throats,
for loading:
positioning the loader bar on the bed portion between the open back end and the front wall,
placing at least one object on the bed portion in a manner that the unloader bar is between the object and the front wall,
moving the object towards the front wall, maintaining the unloader bar between the front wall and the open back end and positioning the free ends of at least one pull line adjacent to the open back end, and, optionally, pulling the objects with the bar toward the open end, and, then, tightening the line about the cleats,
for unloading:
substantially simultaneously pulling the free ends of the pull line in a substantially even manner, wherein to bring the unloader bar into engagement with the object and progressively force the object away from the front wall and towards the open back end; and
for retaining:
placing an object on the bed portion,
positioning the unloader bar rearwardly of the cleats either on the bed portion or the tailgate and rearward of the objects, and
wrapping the free ends of the pull line around a respective of the left and right cleats, wherein the pull line is received in the throats of the cleats.

According to an aspect of this invention, after loading, the pull lines have their free ends wrapped in gripping relation about a respective of the left and right cleats, which wrapping is then reversed for completing the unloading.

As noted, this dual pull unloader system is adaptable to various vehicles, including automotive, aquatic and aviation vehicles having cargo beds or bays. The unloading method is readily applicable to unloading materials from stationary containers.

The foregoing summary, as well as the following detailed description of preferred embodiments, will be better understood when read in conjunction with the accompanying drawings, wherein like numerals refer to like parts throughout. For illustrating the invention, there is shown in the drawings a preferred embodiment, it being understood, however, that the invention is not limited to the specific methods and instrumentalities disclosed. Other objects, features and advantages of the invention will become apparent in the following detailed description of the illustrative embodiments of the invention.

### BRIEF DESCRIPTION OF THE DRAWINGS

FIG. 1 is an isometric view illustrating a dual pull unloader and retainer system in a pickup truck having a tail gate which folds downwardly and provides an open back wherein objects may be loaded into the truck and then either retained at the loading end or moved towards and positioned at the passenger end of the pickup truck;

FIGS. 2, 3, and 4 are plan views illustrating the pickup truck and the dual pull unloader/retainer system, respectively, when objects are received at the loading end of the truck, when objects are stored at the passenger end of the truck, and when objects are retained at the loading end of the truck;

FIG. 5 is a perspective assembly view of a retaining cleat according to the present invention, the cleat including upper and lower body portions and a throat for receiving and retaining a pull line, with a sidewall of the lower body portion partially removed to show pull line gripping ribs;

FIG. 6 is a view of one side of the cleat when assembled and detail of the throat formed therein, and in part by the gripping ribs, for receiving a pull line wound about the cleat and forced into the throat;

FIG. 7 is an end view of the cleat assembly illustrated in FIG. 6;

FIG. 8 is an elevation view of the cleat, taken along line 8-8 of FIG. 7, showing detail of the pull line gripping ribs formed on the upper and lower body portions of the cleat,

FIGS. 9-10 illustrate alternative embodiments of unloader bars according to the present invention,

FIGS. 11-12 illustrate alternative embodiments wherein objects are retained atop the bed and/or the tail gate of the pick up truck, by the unloader bars shown, respectively, in FIGS. 9 and 10,

FIG. 13 is a perspective view of an alternate embodiment of a cleat according to this invention wherein a pair of like shaped body halves are laterally off-set relative to one another, and

FIGS. 14 and 15 are, respectively, an elevation view and a section view taken along line 15-15 of FIG. 14 of an alternative embodiment of a yo-yo shaped cleat according to this invention.

### DESCRIPTION OF A PREFERRED EMBODIMENT OF THE INVENTION

As shown in the drawings for the purposes of illustration, the invention is embodied in a method and apparatus for assisting in the unloading of objects from, or in the retention of objects on, the flat bed portion of a conventional pick-up truck. As can be appreciated, the invention is applicable to stationary containers.

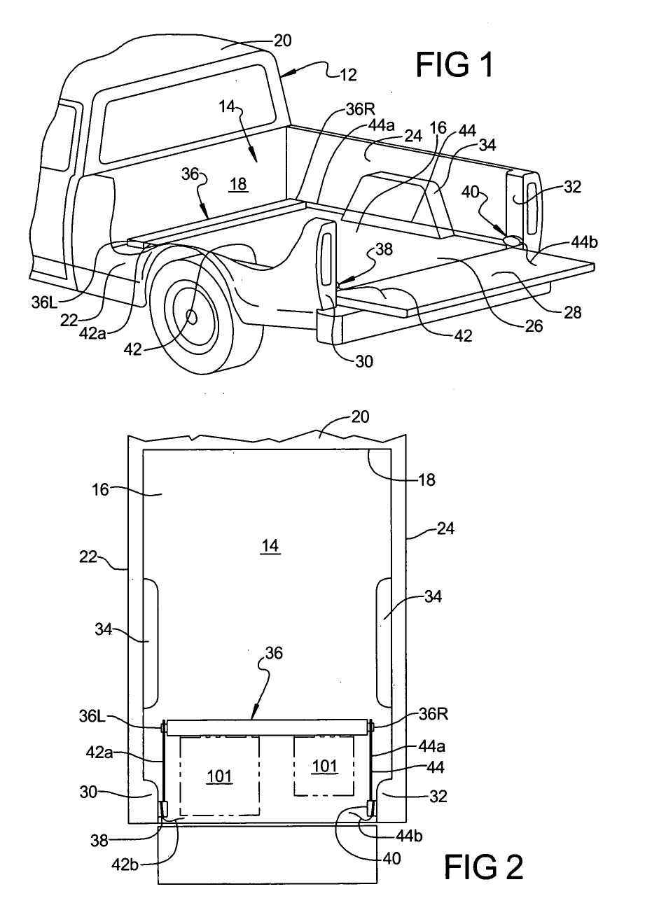

With initial reference to FIG. 1, and in a first embodiment hereof, a dual pull unloading and retention arrangement 10 according to the present invention is installed on a conventional pickup truck 12, such as a Ford model F-150 pickup truck. The truck 12 has a cargo area 14 formed by a flat floor or cargo bed 16, a front wall 18 proximate to a passenger cab 20, a pair of spaced apart left and right sidewalls 22 and 24, an open back end portion 26 (i.e., the loading end of the truck), and a tail gate 28. Each sidewall 22 and 24 includes, respectively, an end frame 30 and 32 and each may be associated with a wheel housing 34. The end frames 30 and 32 form part of the mounting of the tail gate 28 to the truck, and define the open back portion when the tail gate 28 is in the open position (as shown). The left sidewall 22 has material partially cut-away to show detail of the cargo bed 16.

Although the present invention is being described in the context of use on a pickup truck, it can be employed with other types of motor vehicles, boats, trailers, and other mobile transporters, generically referred to herein as a “vehicle” or other types of cargo bays. Further, the unloading arrangement may be equally used in the context of stationary storage containers.

The dual pull unloading and retention arrangement 10 according to the present invention comprises an unloader bar 36 having opposite ends, including a left end 36L and a right end 36R, left and right cleats 38 and 40, and a pair of pull lines 42 and 44. The unloader bar 36 is elongated, generally of uniform rectangular cross-section, and is adapted to engage objects loaded on the cargo bed 16 and be moved across the bed portion, between the sidewalls 22 and 24, and in directions away from and towards the open back end portion 26 (or the front wall 18). While many materials may be used in forming the unloader bar 36, such as a rigid plastic, metal and the like, a conventional piece of wood, or similar lumber, is sufficient in many applications. Also, it should be noted that the bar 36 may be of other geometric shapes such as cylindrical, triangular, etc.

The pull lines 42 and 44 have, respectively, first end portions 42a and 44a, second end portions 42b and 44b, and are of a length greater than the distance between the front wall 18 and the back end portion 26. Desirably, the dual pull lines 42 and 44 enable the user to provide an even pull force on objects being pulled across and unloaded from the cargo bed 16.

The first end portions 42a and 44a of the pull lines 42 and 44 are fixedly connected, respectively, to the left end 36L and right end 36R of the unloader bar 36. The connection, or fastening, between the end portions 42a and 44a and the ends 36L and 36R is not shown as known by those skilled in the art. For example, the ends 42a and 44a of the pull lines could be tied to respective eyebolts, which project outwardly of the unloader bar.

The second end portions 42b and 44b of the pull lines 42 and 44 are adapted to be removably wrapped about, respectively, to the left and right cleat 38 and 40.

The dual pull lines 42 and 44 may comprise a cable, rope, chain, or pull strap formed from any suitable material. Preferably, the pull lines comprise a rope of predetermined diameter “D”.

The cleats 38 and 40 are mounted in faced opposed relation to one another and to the interior wall provided by a respective end frame 30 and 32 at corners of the truck bed at the open end 26 of the cargo area 14. Each cleat 38 and 40 is adapted to receive and secure the second end portion 42b and 44b of a respective pull line 42 and 44, as will be described herein below.

In the double pull unloader mechanism, the cleats 38 and 40 are mounted to a mounting board 46, which board is capable of being removably mounted to the respective sidewall 22 and 24. In the embodiment shown, the mounting board 46, and the cleat associated therewith, does not rotate relative its respective attachment.

In some applications, rotation and shifting movement of the cleat may be desirable. In this regard, and as will be discussed herein below, attention is drawn to the cleat 240 (FIG. 13) with offsettable body halves and the yo-yo shaped cleat 230 (FIGS. 14 and 15) which may be fixedly mounted or adapted to rotate relative to the mounting.

As shown in FIG. 5, the board 46 includes a pair of through bores or apertures 46a, each for receiving a mounting bolt 46b used in connecting the plate to a sidewall at the corner of the truck. Further, the cleat 40 includes through bores 40a, each for receiving a fastener 40b for connecting the cleat to the mounting plate 46. As described herein below, the connection of the cleat to the mounting plate could be other, such as if the cleat is two-part or unitary.

Each cleat 38 and 40 may be formed as a one-piece unit or assembled from two or more portions. However, and as will be described, each cleat 38 and 40 includes a central or medial line “C”, and when mounted to the left and right sidewalls 22 and 24, the medial lines of the cleats are generally parallel to the cargo bed 16.

Further, referring to FIGS. 5 and 8, each cleat 38 and 40 includes first and second sets of pull line gripping ribs 48. Importantly, the ribs 48 in each first set angle upwardly from the medial line “C” and in a direction from the loading end 26 towards the front wall 18, and the ribs 48 in each second set angle downwardly from the medial line “C” and in a direction from the front wall 18 towards the loading end 26. Whether one-piece or assembled, the cleats 38 and 40 are mirror images of one-another and only the cleat 40 mounted on the sidewall 24 of the pickup truck 12 will be described herein. It is to be understood that as a unitary member, the cleat could have its ribs circumferentially disposed therearound with the ribs alternating in angulation or just at different relative angles.

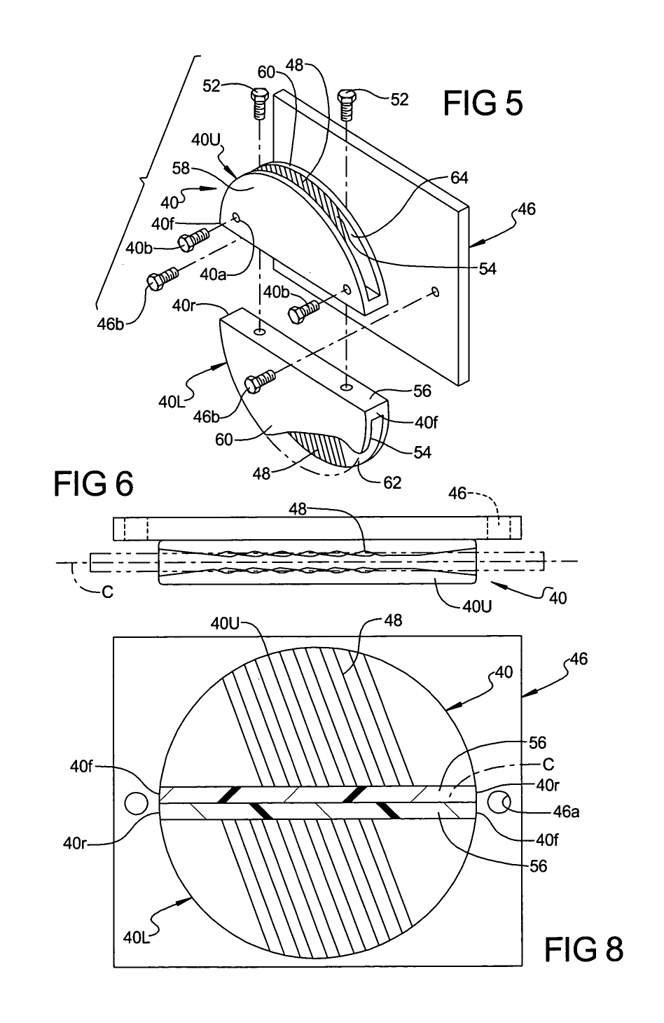

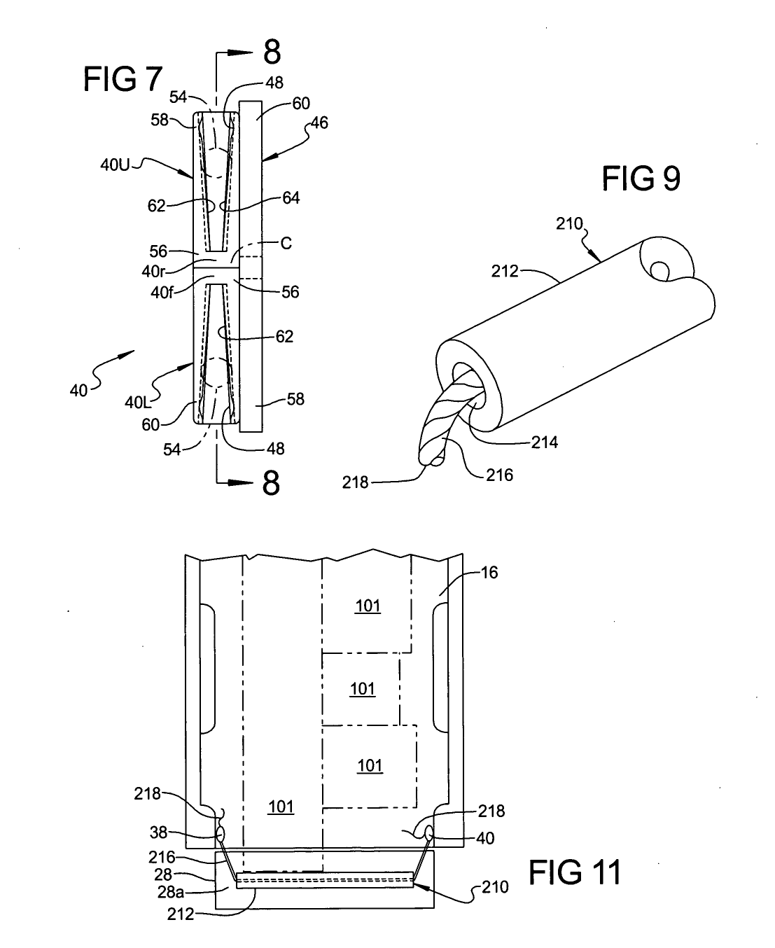

Referring to FIGS. 5-8, the cleat 40 comprises an upper portion 40U and a lower portion 40L, and at least one fastener 52 for joining the upper and lower portions 40U and 40L together. Preferably, the cleat portions 40U and 40L are alike, but rotated 180° relative to one another, such that forward and rearward ends 40f and 40r of the upper portion 40U are juxtaposed, respectively, with the corresponding rearward and forward ends 40r and 40f of the lower portion 40L. As such, the description to follow is of the upper portion 40U, but the description also applies to the lower portion 40L.

The upper portion 40U forms an upwardly open throat 54 sized to receive and removably retain an axial end portion 44b of the pull line 44 when inserted therewithin. As assembled, the throats 54 in the upper and lower portions 40U and 40L are “upwardly open” and face in opposite directions (viz., the throat 54 in the upper portion 40U opens upwardly and faces away from the cargo bed 16 and the throat 54 in the lower portion 40L opens downwardly and faces towards the cargo bed 16).

The upper portion 40 comprises an elongated central base 56 and a pair of upstanding sidewalls 58 and 60, the upstanding sidewalls forming the throat 54. The central base 56 forms the “root” of the throat 54 and is generally parallel to the medial line “C”. The sidewalls 58 and 60 have opposed interior faces 62 and 64 with each face including a set of upstanding ribs 48 for gripping a pull line forced between the sidewalls.

Preferably, the sidewalls 58 and 60 form an upwardly open, generally truncated V-shaped throat 54. The opposed sidewalls 58 and 60 of the throat 54 form a double included angle of about 18°-25°, and have a lateral separation, at least in part, that is less than the outer diameter “D” of the pull line 44 that is to be inserted into the throat, wherein to form a tight interference gripping engagement therewith.

Preferably, the ribs 48 are generally V-shaped projections and are at an angle of about 30°-45° to the medial line, wherein to inhibit unwanted withdrawal of a rope from the throat. Further, in each set of ribs, the cross-section of one rib may differ from that of the next adjacent rib.

According to an aspect of this invention, the cleat members 38 and 40 are comprised of a substantially firm material, such as an elastomer or a polymer. Preferably, the cleat member is comprised of carbon fiber. In this regard, the upper and lower portions 40U and 40L may be integrally molded into one piece, from such material, and this molding attached to the mounting board.

Once formed, the upper and lower portion has, in plan, an exterior shape that is generally oblate (i.e., like a flattened sphere).

Although the method of joining the upper and lower portions 40U and 40L together is by the use of threaded fasteners 52, as shown, the interconnection could be other. For example, a suitable adhesive could be used to bond the central bases together.

Further, interconnection between the upper and lower portions could be as follows (not shown): the mounting plate is provided with an elongated slot, and an L-shaped flange includes a first leg that is juxtaposed against the mounting surface of the mounting plate and a second leg that projects through and outwardly of the outer surface of the mounting plate. The second leg is sandwiched between the central bases of the upper and lower portions 40U and 40L and secured therewith by a fastener 52.

It should be noted and equally preferable herein that the cleats 38 and 40 be mounted on the bed 16 proximate to the tail gate 28 (i.e., the rear or open end) of the truck 12. In this configuration (see FIGS. 11 and 12) the throats of the cleats 38 and 40 are horizontally disposed, as opposed to the throats being vertically oriented (see FIGS. 1-4).

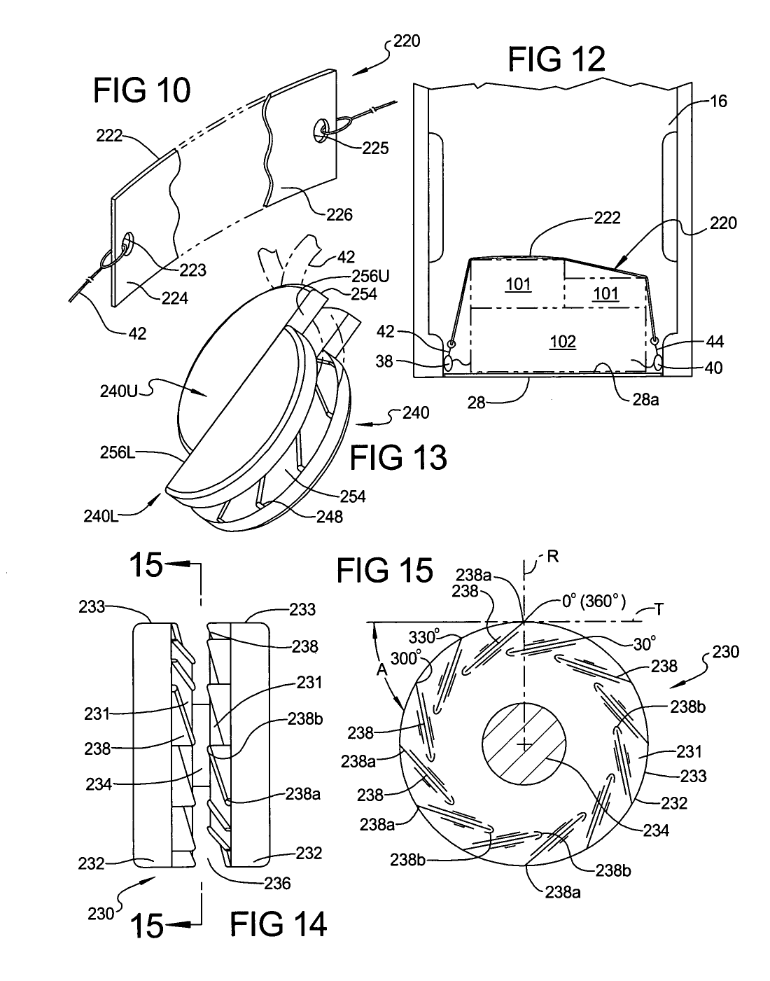

FIGS. 9-10 illustrate further embodiments of unloader bar apparatus 210 and 220 according to the present invention. In the embodiment shown in FIG. 9, the unloader bar 210 may comprise a unitary elongated member 212, formed of any suitable material including a rigid plastic, wood, metal, etc., having a central throughbore 214 extending along the length thereof. In some applications, the elongated member 212 may comprise an elongated cylindrical tube of compliant material, which may conform to the exterior shape and grip the surface of an object to be retained.

By employing an unloader bar 210 of this configuration, only a single pull line 216 need be employed. In use, the pull line 216 is “strung” through the throughbore 214 and the free ends 218 thereof (only one of which being shown in FIG. 9) are secured to opposed vertically disposed cleats (see FIGS. 1-4) or opposite horizontally disposed cleats (see FIGS. 11 and 12).

In the embodiment shown in FIG. 10, the unloader bar 220 may comprise a thin, unitary, elongated, generally rectangular strap 222 formed of a suitable resilient material, including a composite, or single or multiple sheets of plastic, rubber, metal, etc. The opposite lateral ends 224 and 226, respectively, of the strap 222 have an aperture or securement opening 223 and 225 formed therein for connection to a respective pull line 42 and 44 and securement to a respective cleat. The cleats 38 and 40 may be atop and project vertically upwardly from the horizontal bed 16 of the truck or project horizontally outwardly from the vertical sidewalls 22 and 24 of the truck, such that the throats for receiving the ends of the pull lines 42 and 44, or 216, are disposed, respectively, in a horizontal plane or a vertical plane. The wrapping securement of a pull line to a cleat is as described herein below.

FIGS. 11-12 illustrate loading/unloading and retaining arrangements wherein the elongated member 212 of the unloader bar 210, shown in FIG. 9, or the strap 222 of the unloader bar 220, shown in FIG. 10, are used to retain objects in the pick up truck 12 shown in FIG. 1.

Referring to FIG. 11, the tail gate 28 is down and the surface 28a thereof is generally horizontal and parallel with the bed 16. The cleats 38 and 40 are mounted atop and project vertically upwardly from the truck bed 16 and adjacent to rearward loading end of the truck. Objects 101 are loaded atop the bed 16. Due to their irregular size, shape, length, or number, or other considerations, other objects 102 may need to protrude outwardly of the cargo bed 16 of the truck to be supported, at least in part, atop the surface 28a of the gate 28. As shown, the elongated member 212 of the unloader bar 210 is positioned against the object 102 and the opposite ends 218 of the pull line 216 are wrapped or otherwise wound about and secured to a respective cleat on the truck bed 16.

In FIG. 12, a retaining arrangement is illustrated wherein the truck tail gate 28 is vertically disposed and secured in an upright position and one or more objects 102 are retained against the surface 28a of the truck gate 28. As shown, the strap 222 is disposed in generally vertical relation to the truck bed 16 and parallel spaced relation to the gate 16, and the flat portion thereof abutted against the protruding objects 102. The pull lines 42 and 44 have opposite ends, respectively, connected to the openings 223 and 225 and wound about a respective cleat on the truck bed.

The unloader bar 210 may be used in a manner shown in FIG. 12, such as for retaining objects 102 against a raised tail gate 28. In a similar fashion, the unloader bar 220 may be used in a manner shown in FIG. 11 to retain objects, at least in part, atop the tail gate 28, when folded downwardly and horizontally disposed.

FIG. 13 is a perspective view of an alternate embodiment of a cleat 240 according to this invention. The cleat 240 is similar to the cleat 40 described herein above and has upper and lower body halves 240U and 240L, and each body half 240U and 240L includes an annular V-shaped throat 254. Each respective throat 254 is formed by confronting surfaces that are formed, in part, by pull line gripping ribs 248, and is sized to receive a pull line 42 inserted therewithin when the pull line is wrapped about the cleat. The throats 254 and gripping ribs 248 are similar to that described in connection with the cleat 40 (see FIG. 5).

In this embodiment, the upper and lower bodies 240U and 240L each have a respective flat or generally planar base 256U and 256L, and the bodies are interconnected to one another and in a manner that bases 256U and 256L are in juxtaposed confronting relation to one another and off-settingly fixed relative to one another.

FIGS. 14 and 15 are elevation and section views of an alternative embodiment of a yo-yo shaped cleat 230 according to this invention. The cleat 230 comprises a pair of like shaped circular or dish-shaped body halves 232 that are connected to one another by a central shaft 234 and form a V-shaped throat 236, sized to receive a pull line, that extends 360° about the outer circumference 233 of each body half of the cleat 230. The body halves are held in generally parallel spaced relation by the shaft 234 and an interior which expands in width from the shaft radially outwardly to form the V-shaped throat. Each body 232 includes an inner face 231 that is formed to include a plurality of elongated ribs 238, and the faces 231 confront one another. The central shaft 234 and the outer circumferences 233 of the body halves 232 are generally concentric with one another and the throat 236 increases in width radially outwardly from the shaft to the outer circumference 233.

Each rib 238 is generally linear, V-shaped in cross-section, and has opposite tapered ends 238a and 238b, with one end 238a being located proximate to the outer circumference 233 of the body half 232 and the other end 238b being located inwardly and proximate to the shaft 234. The ribs 238 are generally equiangularly disposed and angle inwardly from the outer circumference 233. The ribs 238 on each body half 232 are arranged on the face 231 to give the appearance of a camera lens.

For example, in FIG. 15, proceeding in a counterclockwise direction and considering succeeding first and second ribs, the outer ends of the ribs are proximate to the circumference and located approximately at 0° (360°), 330°, 300°, and so, relative to the geometrical axis of the shaft 234. The first rib has the outer end 238a thereof proximate to the circumference 233 and at 0° and the inner end 238b thereof is radially inwardly of the circumference. Further, the first rib is at an acute angle “A” of about 45° to a tangent “T” drawn to the circumference at 0°. The second rib has the outer end 238a thereof proximate to the circumference 233 and at 330° and the inner end 238b radially inward of the circumference. Similarly, the second rib is at an acute angle “A” of about 45° to a tangent “F” drawn to the circumference at 330°. This arrangement continues in sequence in the manner described.

So arranged, the inner end 238b of the first rib terminates at a location proximate to the inner end of the second rib. Each successive rib is at an acute angle, such as about 45°, to a tangent drawn to the circumference, and has an inner end proximate to the medial or inward end portion of the next succeeding rib 238.

Preferably, the inner ends 238b are spaced from the shaft 234 and generally disposed on a common circle that is concentric with the axis of the shaft.

Preferably the cleat 230 is secured to a panel (not shown), which is then mounted where needed, or directly to the location where needed. The securement may be similar to that illustrated in FIG. 5, wherein the flat surface of one dish-shaped body half 232 is mounted against the panel. The securement may be such that the cleat does not rotate relative to the securement, or may rotate.

This invention provides an unloader that helps reduce the work necessary to unload objects from pick-up trucks and like storage containers. In an important aspect, the unloader described hereinabove also functions as a retention system.

According to this aspect, objects 101 are loaded onto the bed portion 16, the unloader bar 36 is placed at the open back end of the truck, wherein to inhibit objects from sliding out of the truck bed. The end portions 42b and 44b of the pull lines 42 and 44 are disposed at the opposite ends of the unloader bar and wrapped around the throats 54 in each of the respective left and right cleats 38 and 40.

Further and according to this invention, there is provided a method for unloading objects from and retaining objects in a pickup truck or truck trailer, such as described herein above and depicted in FIG. 1. The method includes providing apparatus for unloading and retaining. The apparatus is as described herein above.

As shown in FIG. 2, for loading, the unloader bar 36 is positioned on the bed portion 26 between the open back end and the front wall. At least one object 101 is placed on the bed portion in a manner that the unloader bar is between the object(s) 101 and the front wall 18. The object(s) is moved towards the front wall, with the unloader bar being maintained between the front wall and the open back end and the free ends 42b and 44b of the pull lines 42 and 44 being disposed adjacent to the open back end 26, adjacent to the tail gate 28.

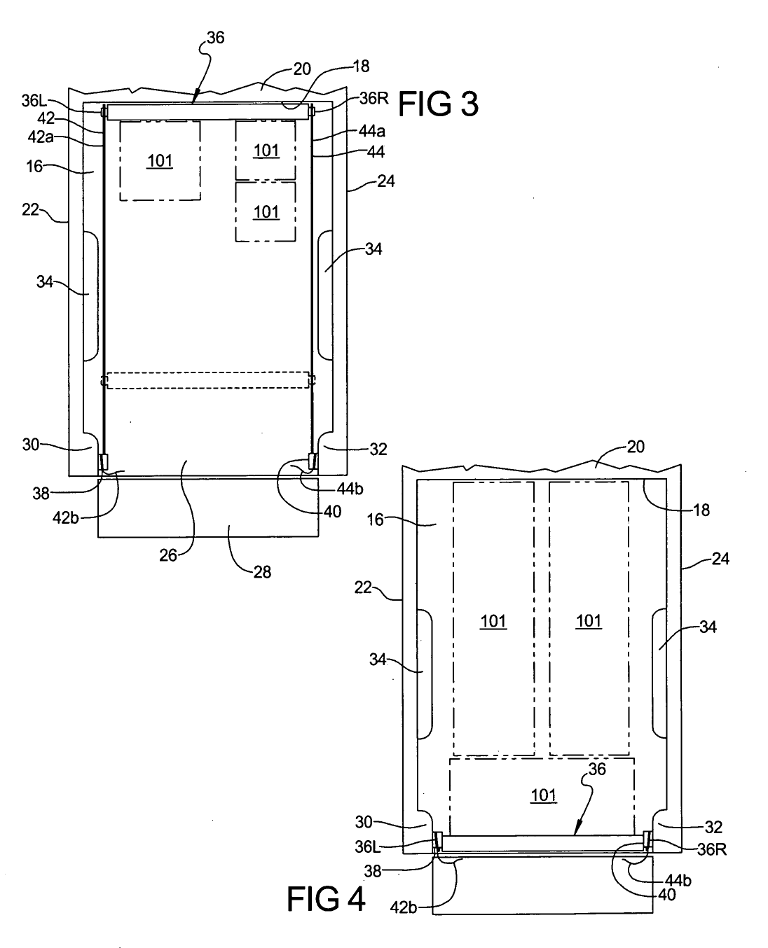

Further, and as shown in FIG. 3, three objects 101 have been positioned in the cargo area 14 of the pickup truck 12, and adjacent to the front wall 18. Preferably, the free ends 42b and 44b of the two pull lines are wrapped around their respective cleats 38 and 40.

As shown in FIG. 3, for unloading, the process just described is reversed. The pull lines are unwrapped (i.e., freed) from their wrapped engagement within the throats of the cleats. Substantially simultaneously, the two pull lines 42 and 44 are pulled in a substantially even manner, in a direction away from the front wall 18 and towards the back open end 26 of the truck, wherein to bring the unloader bar into engagement with the objects. The unloader bar progressively forces the objects 101 away from the front wall and towards the open back end. Sufficient pulling brings the objects to the tail gate 28 for unloading from the truck.

As shown in FIG. 4, for retaining, an object(s) 101 is placed on the bed portion. The unloader bar 36 is positioned on either bed portion 16 or the tailgate rearwardly of and proximate to left and right cleats 38 and 40. Then, the free ends 42b and 44b of the pull lines 42 and 44 are wrapped about a respective of the left and right cleats.

According to an aspect of this invention, after loading, the pull lines preferably have their free ends wrapped in gripping relation about a respective of the left and right cleats, which wrapping is then reversed for completing an unloading. This wrapping is preferable after loading wherein to keep the free ends of the rope from being snagged or otherwise interfered with. Wrapping is essential for the retaining operation. In either rope retaining operation, the pull line is forced downwardly or laterally into one of the throats of the cleat, such as in the upper portion 40U, whereupon the ribs 48 therein grip the pull line to prevent rearward axial withdrawal of the pull line. Then, the pull line is wrapped around and forced downwardly into the other of the throats in the cleat, such as in the lower portion 40L, whereupon the ribs 48 therein grip the pull line to prevent axial withdrawal of the pull line therefrom. The pull line may be wrapped more times, as desired, depending on the diameter of the rope and the separation of the throat walls.

It is further contemplated in the practice hereof that in lieu of the cleats that a winch-type assembly may be used in lieu thereof. In such an assembly a rotatable handle could be used to wrap the free ends of the pull line about a central spool by securing the free ends thereto in a conventional manner and, then, rotating the handle. Preferably, the winch would be a “reversible” winch to effectuate both loading and retaining. Thus, the handle could rotate both clockwise and counter-clockwise in taking up the line depending on the need at that time, using an appropriate gear arrangement.

This dual pull unloader system is adaptable to various vehicles for easy unloading. It is primarily intended to help unload objects from pickup trucks, but can be adapted to unload material from larger trucks and trailers. As noted, the dual pull unloader may be used in unloading from a variety of mobile transporters, whether operating on land, sea, or in the air. The unloading method is also readily applicable to unloading materials from stationary containers.

While the present invention has been described with respect to specific embodiments, it will be understood that from the foregoing detailed description and accompanying drawings that various modifications and variations will occur to those skilled in the art. Such modifications and variations are intended to fall within the scope of the appended claims.

1. A dual pull unloader mechanism for placement and, preferably, for use with a pickup truck or truck trailer, or other cargo bay of the type including a generally flat bed, a front wall, and a back end portion formed in part by opposed vertical first and second sidewalls, comprising:
an unloader bar having opposite first and second ends, the unloader bar being adapted to be engaged by and engage objects loaded on the bed and be moved across the bed, between the sidewalls, and in directions away from and towards the front wall and said open back end portion;
a pair of cleats, one and the other of said cleats being mounted, respectively, to one said first and second sidewall and bed proximate to the back end portion of said cargo bay; and
at least one pull line associated with said unloader bar, said pull line having a pair of free end portions adapted to be wrapped about and secured to a respective cleat and of a length greater than the distance between the front wall and the back end portion of the bed,
wherein for loading the unloader bar is positioned toward the front wall of the bay, such as by objects being loaded being pushed from the back end portion of the bay towards the front wall, and for unloading, the pull line is unwrapped from the cleats and used to apply substantially an even pull force to the unloader bar and progressively pull the bar against the objects and the objects towards the open back end portion of the truck.

2. The dual pull unloader mechanism of claim 1, wherein the unloader bar is elongated and provided with a throughbore extending between said ends and said pull line is one-piece and disposed, in part, in said throughbore, said pull line terminating in said free end portions adapted to be wrapped, respectively, about one and the other cleat.

3. The dual pull unloader mechanism of claim 2, wherein the unloader bar is comprised of a compliant material capable of flexing and bending.

4. The dual pull unloader bar of claim 1, wherein the unloader bar is generally rigid, and said pull line comprises first and second end pull line members each terminating in opposite end portions, one and the other of the opposite end portions comprising a respective of said free end portions and a connectible end connected, respectively, to a respective end of the unloader bar.

5. The dual pull unloader bar of claim 1, wherein the unloader bar is generally compliant, and said pull line comprises first and second end portions connectible, respectively, to one end of the unloader bar and about one said cleat and to the other end of said unloader bar and about the other said cleat.

6. A cleat member for receiving and grippingly retaining a pull rope, comprising a first body half and a second body half disposed generally symmetrically about a medial line, each body half including a pair of opposed sidewalls, each respective pair of sidewalls forming an outwardly open annular throat sized to receive and removably retain a length of pull line inserted therewithin, said throats opening and facing in opposite directions, the sidewalls of each respective throat including a plurality of upstanding ribs for gripping a portion of a pull line forced between the sidewalls and towards the medial line, the ribs in each said throat being at like acute angles to the medial line, wherein to grip and inhibit withdrawal forces operating to pull the pull line outwardly from the throat.

7. The cleat according to claim 6, wherein said cleat is formed as a one piece unit.

8. The cleat according to claim 3, wherein said cleat includes a mounting plate for mounting the cleat to a surface, said first and second body halves being secured to said mounting plate.

9. The cleat according to claim 6, wherein said body halves are comprised of a polymeric material.

10. The cleat according to claim 6, wherein each said body half comprises a generally flat base member having opposite ends, and a pair of sidewalls that project upwardly from the base in spaced relation and terminate in a curved outer periphery which extends between the opposite ends, the throat increasing in width in a direction extending upwardly from the base to the outer periphery, and the sidewalls being generally oblate in shape and unsymmetrical relative to a perpendicular drawn from the midpoint of said base.

11. The cleat according to claim 10, wherein each respective pair of sidewalls are at an acute angle to the plane of the base and medial line and form an upwardly open, generally V-shaped throat, and the ribs are upstanding from the opposed interior faces of the sidewalls, each rib being generally V-shaped in cross-section.

12. The cleat according to claim 11, wherein
the interior faces that form the V-shaped throat define a double included angle of about 18°-25°, and have a lateral separation that is, at least in part, less than the outer diameter of a pull line that is to be inserted into the throat, and the ribs are at an angle of about 30°-45° to the medial line.

13. For use with a pickup truck or truck trailer, or other cargo bay of the type including a generally flat bed, a front wall, and a back end portion for loading objects onto the truck and formed in part by opposed vertical first and second sidewalls and a tail gate movable between a closed upright position and an open horizontal position when deployed, an arrangement for retaining, loading and unloading objects, said arrangement comprising a first and a second cleat, said cleats being disposed at the back end portion and proximate to one and the other of said sidewalls and having an outwardly opening throat for retaining a pull wire, a holder for engaging the objects, and a pull wire connected to the holder, the pull wire having a pair of end portions for connection to one and the other cleat.

14. The arrangement of claim 13 wherein the cleats are on the bed and the throats are disposed in a horizontal plane.

15. The arrangement of claims 13 wherein the first and second cleats are disposed, respectively, on the first and second sidewalls and the throats are disposed in a vertical plane.

16. The arrangement of claim 13, wherein the holder is an elongated hollow tube, the pull wire extends through the holder and retains the objects on the bed and against the tail gate when the tail gate is in the closed position.

17. The arrangement of claim 16, wherein the hollow tube is flexible.

18. The arrangement of claim 16, wherein the holder is elongated, of rigid material, and has opposite ends, and the pull wire is of a length to dispose the holder between the front wall and the objects when pushed to the forward loaded end of the truck, the pull wire including first and second wire portions each having a first end portion connected to a respective end of the holder and a second end portion connected to a respective cleat.

19. The arrangement of claim 16, wherein the holder is elongated and has opposite ends and is adapted to be emplaced atop the tail gate when the gate is in the deployed or down position and supporting objects projecting outwardly from the truck bed, and the pull wire includes first and second wire portions connected to one and the other end of the holder, the wire portions having respective end portions connectible to the one and the other cleat.
